(19) United States
(12) Patent Application Publication
(10) Pub. No.: US 2016/0075372 A1
(43) Pub. Date: Mar. 17, 2016

(54) EARLY FAULT DETECTION FOR AN EPS SYSTEM

(71) Applicant: GM GLOBAL TECHNOLOGY OPERATIONS LLC, Detroit, MI (US)

(72) Inventors: JAMES B. CICERO, MELBOURNE (AU); ROBERT J. TRUBIANI, DONCASTER EAST (AU)

(21) Appl. No.: 14/484,815

(22) Filed: Sep. 12, 2014

(51) Int. Cl. B62D 5/04

(52) U.S. Cl. CPC B62D 5/0496

(57) ABSTRACT

Methods and apparatus are provided for an improved system for early detection of a fault in an EPS system for a vehicle. The apparatus includes a steering gear assembly including a temperature sensor and a pressure sensor for sensing within the steering gear assembly. A controller determines a relationship between the temperature value and the pressure value, and also determines whether the relationship is within a threshold of a reference relationship. The controller can provide an indication or message on a display when the relationship is not within the threshold of the reference relationship. The method includes monitoring a temperature and a pressure associated with an electronic power steering system for a vehicle during operation of the vehicle and determining a relationship between the temperature and the pressure. A fault indication or message is presented on a display when the relationship exceeds a threshold value from a reference relationship.

### TECHNICAL FIELD

The technical field generally relates to electronic power steering (EPS) systems for vehicles, and more particularly to an improved system and method for early detection of a fault in an EPS system for a vehicle.

### BACKGROUND

Electronic power steering (EPS) systems include several mechanical and electronic components to assist an operator of a vehicle with steering maneuvers. One mechanical component important to the operation of EPS systems are the bellows that provide a flexible seal between the steering gear assembly and the tie rods. Should the bellows become damaged or crack due to age, moisture could enter the steering gear assembly. Over time, excess moisture could potentially cause an electrical short or freeze within the steering gear assembly causing it to fail or reduce performance.

Accordingly, it is desirable to provide early detection in any breach of the bellows of an EPS. In addition, it is desirable to notify the operator of the vehicle of the potential for damage so that the vehicle can be repaired more quickly and less expensively than a more serious failure of the EPS system. Furthermore, other desirable features and characteristics of the present invention will become apparent from the subsequent detailed description and the appended claims, taken in conjunction with the accompanying drawings and the foregoing technical field and background.

### SUMMARY

An apparatus is provided for an improved system for early detection of a fault in an EPS system for a vehicle. In one embodiment, the apparatus includes a steering gear assembly including a temperature sensor for measuring a temperature value within a housing of the steering gear assembly and a pressure sensor for measure a pressure value within the steering gear assembly. A controller determines a relationship between the temperature value and the pressure value, and also determines whether the relationship is within a threshold of a reference relationship. The apparatus also includes bellows providing a seal between the housing of the steering gear assembly and tie rods of the vehicle. The controller can determine whether the seal has been compromised and provide an indication or message on a display when the relationship is not within a threshold of the reference relationship.

A method is provided for early detection of a fault in an EPS system for a vehicle. In one embodiment, the method includes monitoring a temperature and a pressure associated with an electronic power steering system for a vehicle during operation of the vehicle and determining a relationship between the temperature and the pressure. A fault indication or message is presented on a display when the relationship exceeds a threshold value from a reference relationship.

### DESCRIPTION OF THE DRAWINGS

The exemplary embodiments will hereinafter be described in conjunction with the following drawing figures, wherein like numerals denote like elements, and wherein:

FIG. 1 is an illustration of a vehicle in accordance with an embodiment;

FIG. 2 is an illustration of the steering gear assembly of FIG. 1 in accordance with an embodiment;

FIG. 3 is an illustration of a processor and sensors of the electronic control unit of FIG. 2 in accordance with an embodiment;

FIGS. 4A-B are illustrations of the temperature and pressure relationship of the steering gear assembly of FIG. 2 in accordance with an embodiment;

FIG. 5 is an illustration of a warning indication in accordance with an embodiment; and

FIG. 6 is flow chart describing a method in accordance with an embodiment.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language.

Additionally, the following description refers to elements or features being “connected” or “coupled” together. As used herein, “connected” may refer to one element/feature being directly joined to (or directly communicating with) another element/feature, and not necessarily mechanically. Likewise, “coupled” may refer to one element/feature being directly or indirectly joined to (or directly or indirectly communicating with) another element/feature, and not necessarily mechanically. However, it should be understood that, although two elements may be described below, in one embodiment, as being “connected,” in alternative embodiments similar elements may be “coupled,” and vice versa. Thus, although the schematic diagrams shown herein depict example arrangements of elements, additional intervening elements, devices, features, or components may be present in an actual embodiment.

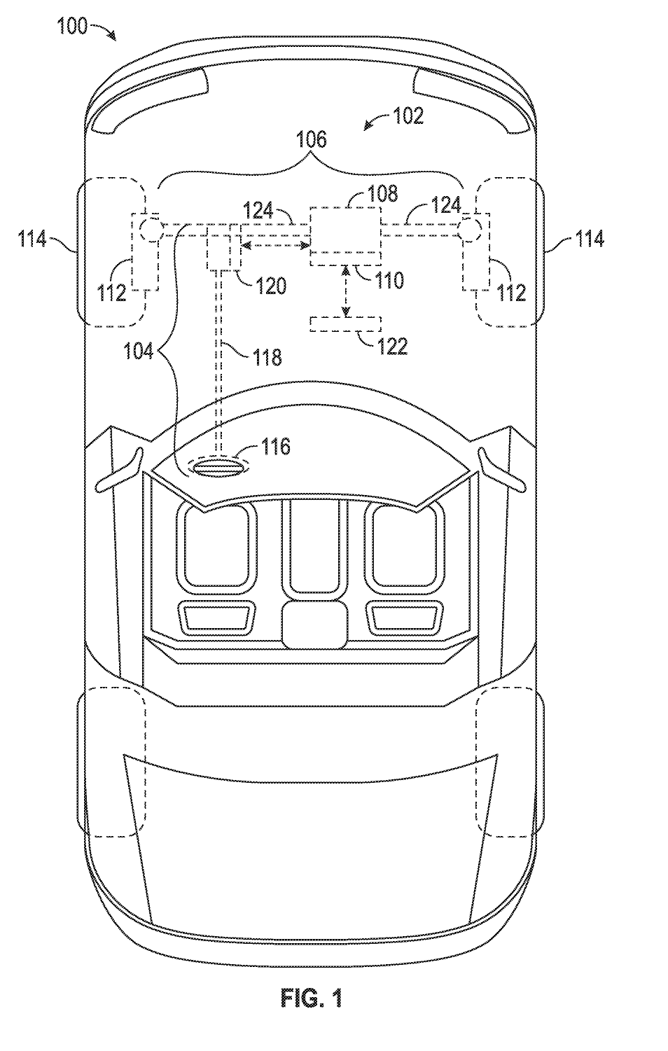

Finally, for the sake of brevity, conventional techniques and components related to vehicle electrical and mechanical parts and other functional aspects of the system (and the individual operating components of the system) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the invention. It should also be understood that FIGS. 1-6 are merely illustrative and may not be drawn to scale.

Referring to the drawings, wherein like reference numbers refer to like components, FIG. 1 shows a vehicle 100 including exemplary embodiments of the present disclosure. The vehicle 100 may be any one of a number of different types of vehicles, such as, for example, a sedan, a wagon, a truck, or a sport utility vehicle (SUV), and may be two-wheel drive (2WD), four-wheel drive (4WD), or all-wheel drive (AWD). The vehicle 100 may also incorporate any one of, or combination of, a number of different types of engines, such as, for example, a gasoline or diesel fueled combustion engine, a flex fuel vehicle (FFV) engine (i.e., using a mixture of gasoline and alcohol), a gaseous compound (e.g., hydrogen and/or natural gas) fueled engine, a combustion/electric motor hybrid engine, and an electric motor.

The illustrated embodiment of the vehicle 100 includes an electronic power steering (EPS) system 102. The EPS system 102 includes a steering column assembly 104, a steering gear assembly 106, a motor assembly 108, a controller 110 and two wheel steering assemblies 112 each coupled to a wheel (and tire) 114. These are, of course, only some of the components, devices, assemblies, systems, etc. that may be used with an EPS system 102, as others known in the art could be used in lieu of or in addition to those mentioned here.

Steering assembly 104 includes a steering wheel 116 rotatably coupled to a steering column 118, which transmits the steering intentions of a driver to the other portions of EPS system 102. Typically, a conventional steering connection assembly 118 includes one or more steering shafts and steering joints that are part of steering connection assembly 118. It should of course be appreciated that the foregoing description is only of a general and exemplary nature as myriad steering connection assembly embodiments, including those having more, less and/or different components could also be used.

The steering connection assembly 118 is coupled to a steering gear assembly 106, which converts rotational motion from the steering connection assembly 118 into lateral or cross-vehicle motion that can be used to turn the vehicle's wheels 114. In some embodiments, steering gear assembly 106 may be realized as a rack and pinion steering gear assembly, although other steering gear assemblies may be used.

The motor assembly 108 provides the EPS system 102 with power assist in order to supplement the manual steering force generated by the driver. This makes steering easier and more effortless. Typically, the motor assembly 108 includes an electric motor, a power input, and one or more gears, pulleys, belts, bearings, etc. for achieving preferred ratios of motor armature to rack velocities. Depending upon the particular embodiment implemented, the electric motor may be a brushless motor, brushed motor, or any other type of motor employed in the art as will be appreciated by those skilled in the art.

The motor assembly 108 operates to provide power assist to steering the vehicle 100 under direction of a controller 110. The controller 110 performs the computation and control functions of the EPS system 102, and may comprise any type of processor or multiple processors, single integrated circuits such as a microprocessor, or any suitable number of integrated circuit devices and/or circuit boards working in cooperation to accomplish the functions of a processing unit. During operation, the controller 110 receives data from sensors (or sensor arrays) 120 and 122, which is used by the controller to determine whether, and to what extent, to provide power assist to the steering effort of the driver of the vehicle 100.

Sensors 120 are coupled to (or integrated within) the steering gear assembly 106. Any sensor capable of taking measurements that provide steering information from the steering connection assembly 118 could be used within sensor 120. As an example, and not a limitation, sensors measuring steering input such as steering wheel angle; steering wheel torque; steering wheel velocity; steering wheel acceleration and steering wheel torque gradient could be useful in sensor array 120.

In addition to steering input derived from driver actions, other vehicle data or conditions may be useful in determining whether (and to what extent) to provide power assisted steering. Accordingly, sensors 122 may be distributed throughout the vehicle 100, but for convenience, are illustrated as a single sensor array coupled to the controller 110. Vehicle sensors that may be useful in determining how to control the motor assembly 108 include, but are not limited to, vehicle speed; vehicle fore-aft acceleration; vehicle lateral acceleration; driven wheel speed and non-driven wheel speed.

In operation of the EPS system 102, the motor assembly 108 provides power assist to move wheel steering assemblies 112, which are coupled to the motor assembly via tie rods 124. Typically, the wheel steering assemblies 112 carry the vehicle's tires and include a number of conventional revolving components. For example, it is common for the wheel steering assemblies 112 to include a rotating hub, a rotating disk or rotor, and a wheel with an installed tire. All of these devices co-rotate when the vehicle 100 is being driven. A disk brake system (not shown) can also be installed on the vehicle to interact with wheel steering assembly 112, although other braking systems like drum brakes could be used as well.

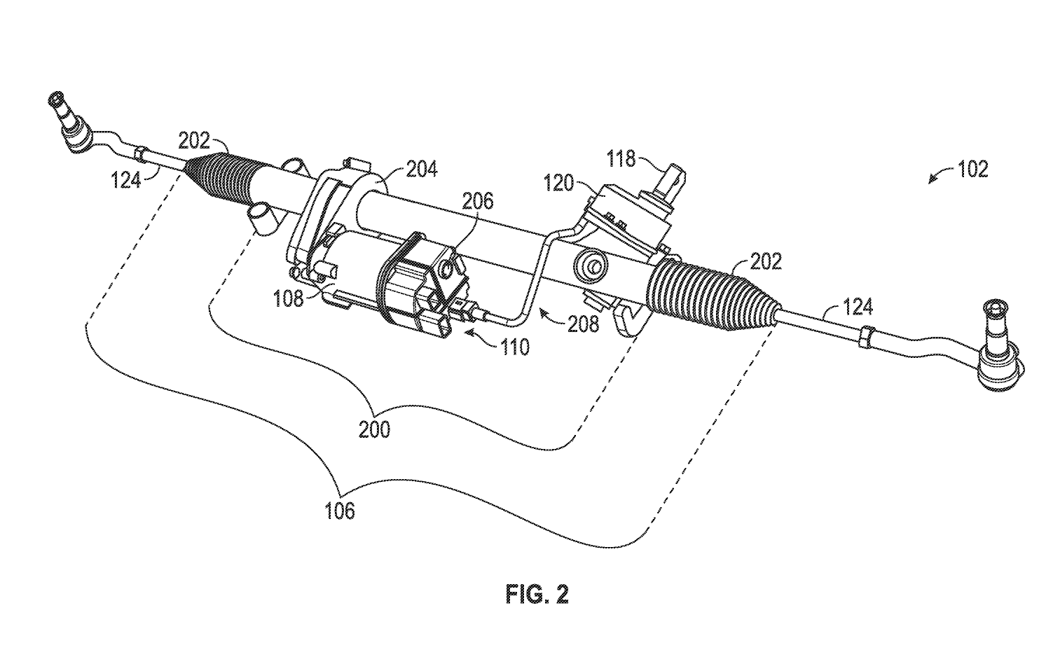

FIG. 2 illustrates the EPS system 102 in more detail. In the illustrated example, the steering gear assembly 106 of the EPS system 102 includes a housing 200 and bellows 202. The bellows 202 provide a flexible seal between the housing 200 and the tie rods 124. As will be appreciated, the bellows will be compressed or extended by tie rod movement during turning maneuvers of the vehicle. The steering gear assembly 106 also includes a motor 108 and controller (e.g., electronic control unit) 110 and a power transfer assembly 204 that applies the power of the motor to the steering gear assembly to assist in steering maneuvers. In some embodiments, the power transfer assembly 204 is realized as a belt drive assembly. A sensor assembly 120 contains any number of sensors desired in any particular implementation of the EPS system 102. Non-limiting examples of sensors include steering wheel angle; steering wheel torque; steering wheel velocity; steering wheel acceleration and steering wheel torque gradient. In some embodiments, the sensor readings may be communicated to the controller 110 via a cable 208 to be used by a processor within the controller.

Being a flexible component and subject to stress in operation, the bellows 202 are the component of the EPS system 102 most likely to become compromised or fail. Road debris by puncture or otherwise damage the bellows 202 such that the seal is breached allowing moisture to ingress into the steering gear assembly. Left uncorrected over a period of time, moisture buildup can reduce the performance of the EPS system 102, or in extreme circumstances, cause the EPS system 102 to fail resulting in loss of power assisted steering. Repair or replacement of the EPS system 102 at this stage would be expensive and time consuming for the operator of the vehicle. Accordingly, fundamental embodiments of the present disclosure provide early detection and warning to the vehicle operator. In this way, a quick and inexpensive repair can be made saving the vehicle operator time and money.

To achieve the benefit, the internal operating temperature and pressure within the steering gear assembly 106 are monitored after engine start and a relationship between the measured temperature and pressure is compared to a reference relationship stored in the controller 110. Since the steering gear assembly 106 is a sealed system (via the bellows 202) a reduction or loss of pressure when the temperature is rising due to operation of the vehicle indicates that the seal has been breached and a repair is needed. As will be appreciated, at any point where pressure can escape the steering gear assembly 106, moisture can ingress and begin to damage the EPS system 102. In some embodiments, a vent 206 is included for venting excess pressure into the atmosphere to prevent an over-pressure situation. In such embodiments, it is preferred to utilize a vent that does not open until a predetermined pressure is reached. In this way, the benefits of the present disclosure can be realized while still providing over-pressure protection for the EPS system 102.

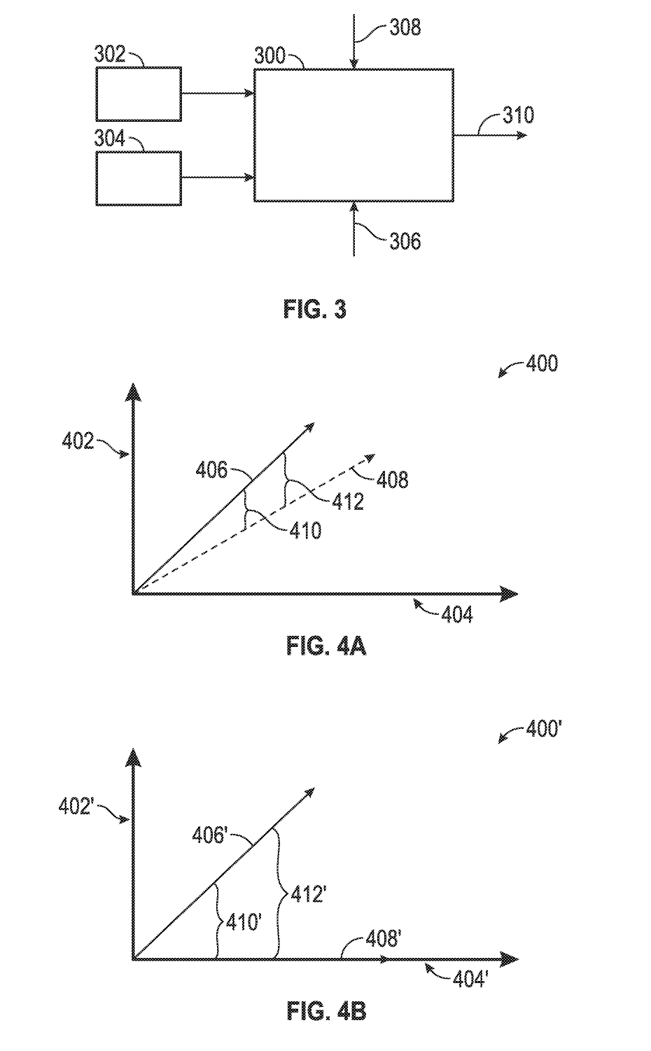

FIG. 3 is a block diagram of the operational components of the controller 110. A processor 300 receives input from a temperature sensor 302 and a pressure sensor 304. The processor 300 also receives an engine run signal 306. The processor uses the engine run signal to determine when to begin measuring the temperature and pressure within the steering gear assembly 106 and determine whether the relationship between the temperature and pressure are within a threshold of a reference relationship stored within the processor 300. Another input 308 to the processor 300 is the steering angle that may be provided by the sensors 120 (or other sensors 122 of FIG. 1). As will be appreciated as the bellows 202 are compressed and extended, the internal pressure will vary in response to this movement. Accordingly, some embodiments use the steering angle input to adjust the pressure input from pressure sensor 304 prior to comparison to the reference relationship. In other embodiments, the steering angle input may utilized such that temperature and pressure measurements are only taken when the steering angle is approximately zero (i.e., the vehicle moving straight ahead) to avoid having the processor make the additional computational adjustments in the measured internal pressure. As will be discussed below, when the measured temperature and pressure relations vary from the reference relationship for the temperature and pressure, the controller 300 sends a signal 310 to cause an indicator or message to appear to the operator of the vehicle, so that the EPS system 102 can be inspected and repaired if needed.

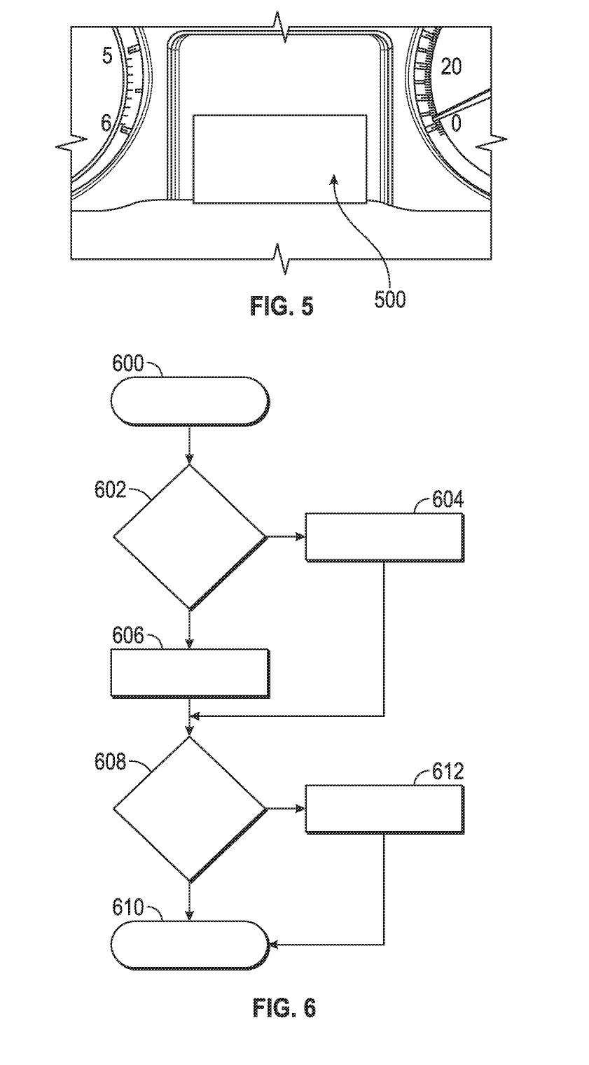

FIGS. 4A-B are diagrams (400 and 400′) illustrating the relationship between the temperature and pressure. The Y axis 402 and 402′ represent increasing temperature and pressure values and the X axis 404 and 404′ represent increasing time from engine start. As can be seen in FIG. 4A, both the internal operating temperature 406 and pressure 408 increase over time during the operation of the EPS system 102. Depending upon the time of measurement, the difference between the temperature value 406 and the pressure value 408 should have a predetermined relationship. As a non-limiting example, the difference between the temperature value 406 and the pressure value 408 at time 410 is less than the difference between the temperature value 406 and the pressure value 408 at time 412. Depending upon the embodiment realized the relationship between the difference between the temperature value 406 and the pressure value 408 can be determined at a single point in time or over several points in time. Moreover, the difference between the temperature value 406 and the pressure value 408 at several points in time can be weighted or averaged depending upon the implementation of the present disclosure. Additionally, statistics can be employed to the temperature value 406 and the pressure value 408 if desired. As will be appreciated, the relationship determining process employed can be any desired process provided that the reference relationship was created (as will be discussed below) in the same manner. While FIG. 4A illustrates a properly functioning EPS system, FIG. 4B illustrates the case of a breach of one or both of the bellows (202 in FIG. 2). As can be seen, while the temperature value 406′ is increasing over time, the pressure value 408′ remains at zero at both time 410′ and 412′. In such a circumstance, the processor (300 in FIG. 3) would determine that the relationship between the temperature value 406′ and the pressure value 408′ is not within a threshold of the reference relationship (which follows FIG. 4A) and provide an indication or message (in display area 500 of FIG. 5) so that the operator of the vehicle could have the EPS system inspected and repair before more serious damage to the EPS system occurs.

FIG. 6 illustrates a flow diagram useful for understanding the method and modes of operation for providing early warning of a fault in an EPS system. The various tasks performed in connection with the methods of FIG. 6 may be performed by software, hardware, firmware, or any combination thereof. For illustrative purposes, the following description of the methods of FIG. 6 may refer to elements mentioned above in connection with FIGS. 1-3. In practice, portions of the methods of FIG. 6 may be performed by different elements of the described system. It should also be appreciated that the methods of FIG. 6 may include any number of additional or alternative tasks and that the methods of FIG. 6 may be incorporated into a more comprehensive procedure or process having additional functionality not described in detail herein. Moreover, one or more of the tasks shown in FIG. 6 could be omitted from an embodiment of the methods of FIG. 6 as long as the intended overall functionality remains intact.

The method 600 begins in block 602 where the controller (110 in FIG. 3) detects an engine start (signal 306 if FIG. 3) and determines whether this is an initial engine start for the vehicle. The initial engine start determination is used to create the reference relation for the operating temperature and pressure within the steering gear assembly (106 in FIG. 2). In some embodiments, initial engine start can be detected by the reference relationship not being present in a memory location of the processor 300. Typically, the first engine start at the factory will cause a determination of an initial engine start. However, another initial engine start situation would arise after a repair to the EPS system. For example, one or both of the bellows (202 in FIG. 2) may have been replaced during a repair procedure. As will be appreciated, over time new material or specifications for the bellows may have been introduced that would cause a change in measured temperature and pressure. Accordingly, after a repair, the technician would cause the controller 110 to reset (or clear) the reference relationship so that the next engine start would be detected as an initiation engine start and cause the creation of a new reference relationship (block 604) by taking measurements over time as discussed above in connection with FIG. 4A. Conversely, if block 602 determines that the detected engine start is not an initial engine start, the routine proceeds to block 606 where the internal operating temperature and pressure are measured over time. Next, block 608 determines whether the relationship between the measured temperature and pressure are within a threshold of the reference relationship for the temperature and pressure provided by block 604. If so, the routine ends in block 610 until the next engine start. If not, then block 612 provides a warning indication or message to the operator of the vehicle such as illustrated in FIG. 5.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method, comprising:
monitoring, by a processor, a temperature associated with an electronic power steering system for a vehicle during operation of the vehicle;
monitoring, by the processor, a pressure associated with an electronic power steering system for the vehicle during operation of the vehicle;
determining, by the processor, a relationship between the temperature and the pressure; and
presenting an indication or message on a display when the relationship exceeds a threshold value.

2. The method of claim 1, wherein monitoring the temperature comprises monitoring an internal operating temperature of a housing of the electronic power steering system.

3. The method of claim 1, wherein monitoring the pressure comprises monitoring, by an internal operating pressure of a steering gear assembly of the electronic power steering system.

4. The method of claim 3, where in the housing includes a vent for releasing internal pressure of the gear assembly after the internal pressure exceeds a threshold.

5. The method of claim 1, wherein determining the relationship between the temperature and the pressure comprises comparing a measured temperature value to a measured pressure value over a time period after an engine of the vehicle has been started.

6. The method of claim 5, wherein the processor receives a steering angle value and determining the relationship between the temperature and the pressure comprises adjusting the measured pressure value responsive to the steering angle value prior to comparing the measured temperature value to the measured pressure value.

7. The method of claim 1, wherein presenting the indication or message on the display further comprises comparing the relationship to a reference relationship and presenting the indication or message on the display when the relationship and the reference relationship exceed the threshold.

8. The method of claim 7, further comprising detecting an initial start of an engine of the vehicle and creating the reference relationship by measuring the temperature and the pressure associated with the electronic power steering system during operation of the vehicle.

9. An electronic power steering system, comprising:
a steering gear assembly including:
a temperature sensor for measuring a temperature value within a housing of the steering gear assembly;
a pressure sensor for measure a pressure value within the steering gear assembly; and
a controller coupled to the temperature sensor and the pressure sensor for determining a relationship between the temperature value and the pressure value, and for determining whether the relationship is within a threshold of a reference relationship;
and
bellows providing a seal between the housing of the steering gear assembly and tie rods of the vehicle;
wherein, the controller determines whether the seal has been compromised and provide an indication or message on a display when the relationship is not within the threshold of the reference relationship.

10. The electronic power steering system of claim 9, where in the housing includes a vent for releasing internal pressure of the gear assembly after the internal pressure exceeds a threshold.

11. The electronic power steering system of claim 9, wherein the controller is configured to determine the relationship between the temperature and the pressure by comparing a measured temperature value to a measured pressure value over a time period after an engine of the vehicle has been started.

12. The electronic power steering system of claim 9, wherein the controller receives a steering angle value and is configure to determine the relationship between the temperature and the pressure by adjusting the measured pressure value responsive to the steering angle value prior to comparing the measured temperature value to the measured pressure value.

13. The electronic power steering system of claim 9, wherein presenting the indication or message on the display further comprises the controller comparing the relationship to a reference relationship and presenting the indication or message on the display when the relationship and the reference relationship exceed the threshold.

14. The electronic power steering system of claim 9, wherein the controller is configured to detect an initial start of an engine of the vehicle and create the reference relationship by measuring the temperature and the pressure associated with the electronic power steering system during operation of the vehicle.

15. A vehicle, comprising:
wheels;
an engine to apply drive power to the wheels
tie rods coupled to the wheels;
an electronic power steering (EPS) system coupled to the tie rods, the EPS system including:
a steering gear assembly including:
a temperature sensor for measuring a temperature value within a housing of the steering gear assembly;
a pressure sensor for measure a pressure value within the steering gear assembly; and
a controller coupled to the temperature sensor and the pressure sensor for determining a relationship between the temperature value and the pressure value, and for determining whether the relationship is within a threshold of a reference relationship;
and
bellows providing a seal between the housing of the steering gear assembly and the tie rods;
wherein, the controller determines whether the seal has been compromised and provide an indication or message on a display when the relationship is not within the threshold of the reference relationship.

16. The vehicle of claim 15, where in the housing includes a vent for releasing internal pressure of the gear assembly after the internal pressure exceeds a threshold.

17. The vehicle of claim 15, wherein the controller is configured to determine the relationship between the temperature and the pressure by comparing a measured temperature value to a measured pressure value over a time period after an engine of the vehicle has been started.

18. The vehicle of claim 15, wherein the controller receives a steering angle value and is configured to determine the relationship between the temperature and the pressure by adjusting the measured pressure value responsive to the steering angle value prior to comparing the measured temperature value to the measured pressure value.

19. The vehicle of claim 15, wherein presenting the indication or message on the display further comprises the controller comparing the relationship to a reference relationship and presenting the indication or message on the display when the relationship and the reference relationship exceed the threshold.

20. The vehicle of claim 15, wherein the controller is configured to detect an initial start of an engine of the vehicle and create the reference relationship by measuring the temperature and the pressure associated with the electronic power steering system during operation of the vehicle.
